(19) United States
(12) Patent Application Publication
(10) Pub. No.: US 2022/0355542 A1
(43) Pub. Date: Nov. 10, 2022

(54) SELECTIVE DEPOSITION-BASED ADDITIVE MANUFACTURING USING DISSIMILAR MATERIALS

(71) Applicant: Evolve Additive Solutions, Inc., Minnetonka, MN (US)

(72) Inventor: J. Samuel Batchelder, Somers, NY (US)

(21) Appl. No.: 17/622,554

(22) PCT Filed: Jun. 30, 2020
(86) PCT No.: PCT/US2020/040317

§ 371 Date: Dec. 23, 2021

Related U.S. Application Data
(60) Provisional application No. 62/870,451, filed on Jul. 3, 2019.

(51) Int. Cl. B29C 64/147; B33Y 10/00; B33Y 30/00; G03G 15/22

(52) U.S. Cl. CPC B29C 64/147; B33Y 10/00; B33Y 30/00; G03G 15/224

(57) ABSTRACT

In a method of printing a 3D part in accordance with a selective deposition additive manufacturing process a first image portion of a flowable material is developed using a first electrophotographic engine. A second image portion of a resilient material is developed using a second electrophotographic engine. The first image portion is registered with respect to the second image portion to form a combined image layer comprising the first and second image portions on a transfer medium. The combined image layer is transfused from the transfer medium to a part build surface of a 3D part. The viscosity (Vr) of the resilient material is greater than or equal to three times the viscosity (Vf) of the flowable material, and/or the storage modulus (Er) of the resilient material is greater than or equal to three times the storage modulus (Ef) of the flowable material.

This application is being filed as a PCT International Patent application on Jun. 30, 2020, in the name of Evolve Additive Solutions, Inc., a U.S. national corporation, applicant for the designation of all countries, and J. Samuel Batchelder, a U.S. Citizen, inventor for the designation of all countries, and claims priority to U.S. Provisional Patent Application No. 62/870,451, filed Jul. 3, 2019, the contents of which are herein incorporated by reference in its entirety.

### BACKGROUND

The present disclosure relates to additive manufacturing systems for printing three-dimensional (3D) parts and support structures. In particular, the present disclosure relates to a selective deposition additive manufacturing process using dissimilar materials.

Additive manufacturing is generally a process for manufacturing a three-dimensional (3D) object in additive manner utilizing a computer model of the objects The basic operation of an additive manufacturing system consists of slicing a three-dimensional computer model into thin cross sections, translating the result into position data, and the position data to control equipment which manufacture a three-dimensional structure in a layerwise manner using one or more additive manufacturing techniques. Additive manufacturing entails many different approaches to the method of fabrication, including fused deposition modeling, ink jetting, selective laser sintering, powder/binder jetting, electron-beam melting, electrophotographic imaging, and stereolithographic processes.

In fabricating 3D parts by depositing layers of a part material, supporting layers or structures are typically built underneath overhanging portions or in cavities of objects under construction, which are not supported by the part material itself. A support structure may be built utilizing the same deposition techniques by which the part material is deposited. The host computer generates additional geometry acting as a support structure for the overhanging or free-space segments of the 3D part being formed, and in some cases, for the sidewalls of the 3D part being formed. The support material adheres to the part material during fabrication, and is removable from the completed 3D part when the printing process is complete.

In an electrostatographic 3D printing process, slices of the digital representation of the 3D part and its support structure are printed or developed using an electrophotographic engine. The electrostatographic engine generally operates in accordance with 2D electrophotographic printing processes, using charged powder materials that are formulated for use in building a 3D part (e.g., a polymeric toner material). The electrostatographic engine typically uses a support drum that is coated with a photoconductive material layer, where latent electrostatic images are formed by electrostatic charging following image-wise exposure of the photoconductive layer by an optical source. The latent electrostatic images are then moved to a developing station where the polymeric toner is applied to charged areas, or alternatively to discharged areas of the photoconductive insulator to form the layer of the charged powder material representing a slice of the 3D part. The developed layer is transferred to a transfer medium, from which the layer is transfused to previously printed layers with heat and pressure to build the 3D part.

In addition to the aforementioned commercially available additive manufacturing techniques, a novel additive manufacturing technique has emerged, where particles are first selectively deposited in an imaging process, forming a layer corresponding to a slice of the part to be made, which may include a support portion formed of a support material. The layers are then bonded to each other, forming a part and support structure. This is a selective deposition process, in contrast to, for example, selective sintering, where the imaging and part formation happens simultaneously. The imaging step in a selective deposition process can be done using electrophotography. In two-dimensional (2D) printing, electrophotography (i.e., xerography) is a popular technology for creating 2D images on planar substrates, such as printing paper. Electrophotography systems include a conductive support drum coated with a photoconductive material layer, where latent electrostatic images are formed by charging and then image-wise exposing the photoconductive layer by an optical source. The latent electrostatic images are then moved to a developing station where toner is applied to charged areas of the photoconductive insulator to form visible images. The formed toner images are then transferred to substrates (e.g., printing paper) and affixed to the substrates with heat or pressure.

Previously disclosed selective deposition processes have emphasized the critical importance that the materials used to form the part and support structures be compatible in order for the layer-building process to be properly performed. Specifically, previously disclosed selective deposition processes require the part and support materials to have similar rheologies including similar viscosities and similar storage moduli within operational temperature ranges. As a result, the types of materials used in selective deposition processes have been significantly limited to those having very similar rheologies.

### SUMMARY

Embodiments of the present disclosure are directed to the use of materials having dissimilar rheologies in a selective deposition process to form part and/or support structures. In one embodiment of a method of printing a 3D part through a selective deposition additive manufacturing process, a first image portion of a flowable material is developed using a first electrophotographic engine. A second image portion of a resilient material is developed using a second electrophotographic engine. The first image portion is registered with respect to the second image portion to form a combined image layer comprising the first and second image portions on a transfer medium. The combined image layer is transfused from the transfer medium to a part build surface of a 3D part.

In one aspect of the method, the combined image layer is transfused from the transfer medium to a part build surface of a 3D part using a nip roller. The resilient material has a viscosity Vr at a nip entrance temperature corresponding to a surface temperature of the combined image layer at the nip roller, and the flowable material has a viscosity Vf at the nip entrance temperature. Furthermore, the viscosity (Vr) of the resilient material is greater than or equal to three times the viscosity (Vf) of the flowable material. Thus, Vr≥3*Vf.

In accordance with another aspect, the resilient material has a storage modulus Er at a bulk temperature corresponding to the average temperature of the 3D part at depth of about 50-100 mils from the part build surface. The flowable material has a storage modulus of Ef at the bulk temperature. The storage modulus (Er) of the resilient material is greater than or equal to three times the storage modulus (Ef) of the flowable material. Thus, Er≥3*Ef.

### Definitions

Unless otherwise specified, the following terms as used herein have the meanings provided below:

The term “copolymer” refers to a polymer having two or more monomer species.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the inventive scope of the present disclosure.

Reference to “a” chemical compound refers one or more molecules of the chemical compound, rather than being limited to a single molecule of the chemical compound. Furthermore, the one or more molecules may or may not be identical, so long as they fall under the category of the chemical compound.

The terms “at least one” and “one or more of” an element are used interchangeably, and have the same meaning that includes a single element and a plurality of the elements, and may also be represented by the suffix “(s)” at the end of the element.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The term “selective deposition” refers to an additive manufacturing technique where one or more layers of particles are fused to previously deposited layers utilizing heat and pressure over time where the particles fuse together to form a layer of the part and also fuse to the previously printed layer.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

The terms “resilient material” and “flowable material” describe distinct materials used in the printing of a 3D part and support. The resilient material has a higher viscosity and/or storage modulus relative to the flowable material.

Unless otherwise specified, temperatures referred to herein are based on atmospheric pressure (i.e. one atmosphere).

The terms “about” and “substantially” are used herein with respect to measurable values and ranges due to expected variations known to those skilled in the art (e.g., limitations and variabilities in measurements).

### BRIEF DESCRIPTION OF THE DRAWINGS

FIG. 1 is a front view of an exemplary electrophotography-based additive manufacturing system for printing 3D parts and support structures from part and support materials, in accordance with embodiments of the present disclosure.

FIG. 2 is a schematic front view of a pair of electrophotography engines of the system for developing layers of the part and support materials, in accordance with embodiments of the present disclosure.

FIG. 3 is a schematic front view of an alternative electrophotography engine, which includes an intermediary drum or belt, in accordance with embodiments of the present disclosure.

FIG. 4 is a schematic front view of a layer transfusion assembly of the system for performing layer transfusion steps with the developed layers, in accordance with embodiments of the present disclosure.

FIG. 5 is a simplified diagram illustrating an exemplary combined image layer on a transfer medium before and after transfer to a 3D part, in accordance with previously disclosed selective deposition processes.

FIG. 6 is a simplified diagram illustrating an exemplary combined image layer on a transfer medium before and after transfer to a 3D part, in accordance with embodiments of the present disclosure.

FIG. 7 is a simplified diagram illustrating an exemplary process of registering a printed layer, in accordance with embodiments of the present disclosure.

### DETAILED DESCRIPTION

Embodiments of the present disclosure relate to a selective deposition-based additive manufacturing system, such as an electrostatography-based additive manufacturing system, to print 3D parts and/or support structures with high resolutions and fast printing rates. During a printing operation, electrostatographic engines may develop or otherwise image each layer of the part and support materials using the electrostatographic process. The developed layers are then transferred to a layer transfusion assembly where they are transfused (e.g., using heat and/or pressure over time) to print one or more 3D parts and support structures in a layer-by-layer manner.

In comparison to 2D printing, in which developed toner particles can be electrostatically transferred to printing paper by placing an electrical potential through the printing paper, the multiple printed layers in a 3D environment effectively prevents the electrostatic transfer of part and support materials after a given number of layers are printed (e.g., about 15 layers). Instead, each layer and/or previously printed portion of the 3D part may be heated to an elevated transfer temperature, and then pressed against a previously-printed layer (or to a build platform) to transfuse the layers together in a transfusion step. This allows numerous layers of 3D parts and support structures to be built, beyond what is otherwise achievable via electrostatic transfers.

Embodiments of the present disclosure make use of substantially dissimilar materials for forming the 3D part and support structure relative to the materials used in previously disclosed selective deposition processes. This leads to several advantages over the previously disclosed selective deposition processes including the expansion of the materials that may be used to form the 3D part and support structure and other advantages discussed below in greater detail.

While the present disclosure can be utilized with any electrostatography-based additive manufacturing system, the present disclosure will be described in association in an electrophotography-based (EP) additive manufacturing system. However, the present disclosure is not limited to an EP based additive manufacturing system and can be utilized with any electrostatography-based additive manufacturing system.

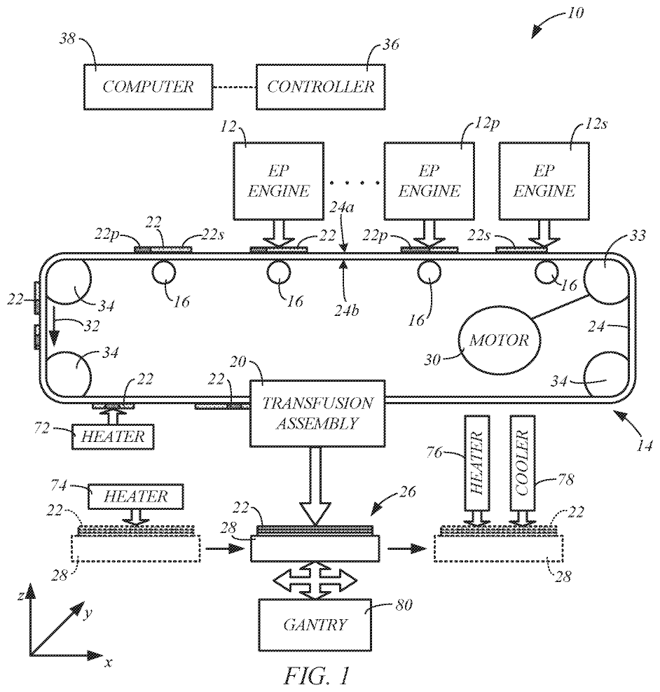

FIG. 1 is a simplified diagram of an exemplary electrophotography-based additive manufacturing system 10 configured to perform a selective deposition process to printing 3D parts and associated support structures, in accordance with embodiments of the present disclosure. As shown in FIG. 1, system 10 includes one or more EP engines, generally referred to as 12, such as EP engines 12p and 12s, a transfer assembly 14, biasing mechanisms 16, and a transfusion assembly 20. Examples of suitable components and functional operations for system 10 include those disclosed in Hanson et al., U.S. Pat. Nos. 8,879,957 and 8,488,994, and in Comb et al., U.S. Patent Publication Nos. 2013/0186549 and 2013/0186558.

The EP engines 12p and 12s are imaging engines for respectively imaging or otherwise developing layers, generally referred to as 22, of the powder-based part and support materials, where the part and support materials are each preferably engineered for use with the particular architecture of the EP engine 12p or 12s. As discussed below, the developed layers 22 are transferred to a transfer medium (e.g. belt 24) of the transfer assembly 14, which delivers the layers 22 to the transfusion assembly 20. The transfusion assembly 20 operates to build the 3D part 26, which may include support structures and other features, in a layer-by-layer manner by transfusing the layers 22 together on a build platform 28.

In some embodiments, the transfer medium includes a belt 24, as shown in FIG. 1. Examples of suitable transfer belts for the transfer medium (such as belt 24) include those disclosed in Comb et al., U.S. Patent Application Publication Nos. 2013/0186549 and 2013/0186558. In some embodiments, the belt 24 includes front surface 24a and rear surface 24b, where front surface 24a faces the EP engines 12, and the rear surface 24b is in contact with the biasing mechanisms 16.

In some embodiments, the transfer assembly 14 includes one or more drive mechanisms that include, for example, a motor 30 and a drive roller 33, or other suitable drive mechanism, and operate to drive the transfer medium or belt 24 in a feed direction 32. In some embodiments, the transfer assembly 14 includes idler rollers 34 that provide support for the belt 24. The example transfer assembly 14 illustrated in FIG. 1 is highly simplified and may take on other configurations. Additionally, the transfer assembly 14 may include additional components that are not shown in order to simplify the illustration, such as, for example, components for maintaining a desired tension in the belt 24, a belt cleaner for removing debris from the surface 24a that receives the layers 22, and other components.

The EP engine 12s develops layer or image portions 22s of powder-based support material, and the EP engine 12p develops layer or image portions 22p of powder-based part/build material. In some embodiments, the EP engine 12s is positioned upstream from the EP engine 12p relative to the feed direction 32, as shown in FIG. 1. In alternative embodiments, the arrangement of the EP engines 12p and 12s may be reversed such that the EP engine 12p is upstream from the EP engine 12s relative to the feed direction 32. In further alternative embodiments, system 10 may include three or more EP engines 12 for printing layers of additional materials, as indicated in FIG. 1.

System 10 also includes controller 36, which represents one or more processors that are configured to execute instructions, which may be stored locally in memory of the system 10 or in memory that is remote to the system 10, to control components of the system 10 to perform one or more functions described herein. In some embodiments, the controller 36 includes one or more control circuits, microprocessor-based engine control systems, and/or digitally-controlled raster imaging processor systems, and is configured to operate the components of system 10 in a synchronized manner based on printing instructions received from a host computer 38 or a remote location. In some embodiments, the host computer 38 includes one or more computer-based systems that are configured to communicate with controller 36 to provide the print instructions (and other operating information). For example, the host computer 38 may transfer information to the controller 36 that relates to the sliced layers of the 3D parts and support structures, thereby allowing the system 10 to print the 3D parts 26 and support structures in a layer-by-layer manner. The controller 36 may also use signals from one or more sensors to assist in properly registering the printing of the part or image portion 22p and/or the support structure or image portion 22s with a previously printed corresponding support structure portion 22s or part portion 22p on the belt 24 to form the individual layers 22.

The components of system 10 may be retained by one or more frame structures (not shown for simplicity). Additionally, the components of system 10 may be retained within an enclosable housing (not shown for simplicity) that prevents components of the system 10 from being exposed to ambient light during operation.

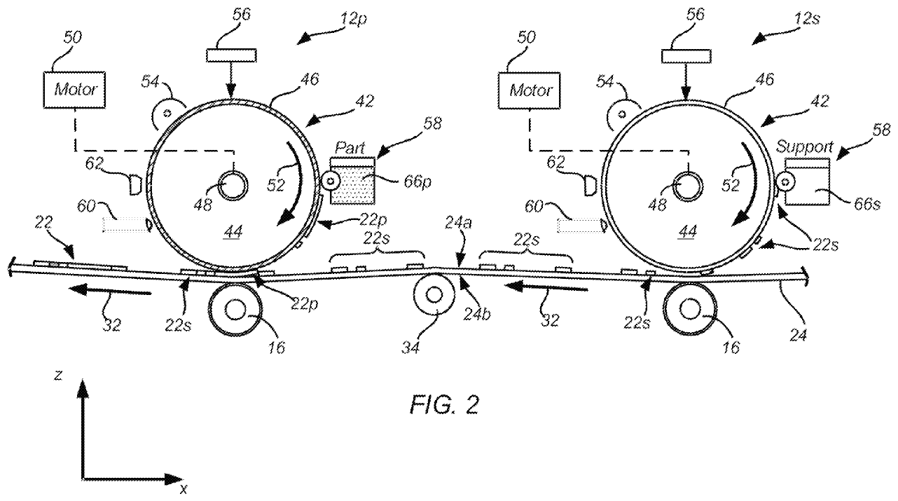

FIG. 2 is a schematic front view of the EP engines 12s and 12p of the system 10, in accordance with example embodiments of the present disclosure. In the illustrated embodiment, the EP engines 12p and 12s may include the same components, such as a photoconductor drum 42 having a conductive drum body 44 and a photoconductive surface 46. The conductive drum body 44 is an electrically-conductive drum (e.g., fabricated from copper, aluminum, tin, or the like) that is electrically grounded and configured to rotate around a shaft 48. The shaft 48 is correspondingly connected to a drive motor 50, which is configured to rotate the shaft 48 (and the photoconductor drum 42) in the direction 52 (shown by an arrow) at a constant rate.

The photoconductive surface 46 is a thin film extending around the circumferential surface of the conductive drum body 44, and is preferably derived from one or more photoconductive materials, such as amorphous silicon, selenium, zinc oxide, organic materials, and the like. As discussed below, the surface 46 is configured to receive latent-charged images of the sliced layers of a 3D part or support structure (or negative images), and to attract charged particles of the part or support material to the charged or discharged image areas, thereby creating the layers of the 3D part or support structure.

As further shown, each of the example EP engines 12p and 12s also includes a charge inducer 54, an imager 56, a development station 58, a cleaning station 60, and a discharge device 62, each of which may be in signal communication with the controller 36. The charge inducer 54, the imager 56, the development station 58, the cleaning station 60, and the discharge device 62 accordingly define an image-forming assembly for the surface 46 while the drive motor 50 and the shaft 48 rotate the photoconductor drum 42 in the direction 52.

Each of the EP engines 12 uses the powder-based material (e.g., polymeric or thermoplastic toner), generally referred to herein by reference character 66, to develop or form the layers 22. In some embodiments, the image-forming assembly for the surface 46 of the EP engine 12s is used to form support layers 22s (e.g., image portions) of powder-based support material 66s, where a supply of the support material 66s may be retained by the development station 58 (of the EP engine 12s) along with carrier particles. Similarly, the image-forming assembly for the surface 46 of the EP engine 12p is used to form part layers 22p (e.g., image portion) of powder-based part material 66p, where a supply of the part material 66p may be retained by the development station 58 (of the EP engine 12p) along with carrier particles. Additional EP engines 12 may be included that utilize other support or part materials 66.

The charge inducer 54 is configured to generate a uniform electrostatic charge on the surface 46 as the surface 46 rotates in the direction 52 past the charge inducer 54. Suitable devices for the charge inducer 54 include corotrons, scorotrons, charging rollers, and other electrostatic charging devices.

Each imager 56 is a digitally-controlled, pixel-wise light exposure apparatus configured to selectively emit electromagnetic radiation toward the uniform electrostatic charge on the surface 46 as the surface 46 rotates in the direction 52 the past imager 56. The selective exposure of the electromagnetic radiation to the surface 46 is directed by the controller 36, and causes discrete pixel-wise locations of the electrostatic charge to be removed (i.e., discharged to ground), thereby forming latent image charge patterns on the surface 46.

Suitable devices for the imager 56 include scanning laser (e.g., gas or solid-state lasers) light sources, light emitting diode (LED) array exposure devices, and other exposure device conventionally used in 2D electrophotography systems. In alternative embodiments, suitable devices for the charge inducer 54 and the imager 56 include ion-deposition systems configured to selectively directly deposit charged ions or electrons to the surface 46 to form the latent image charge pattern.

Each development station 58 is an electrostatic and magnetic development station or cartridge that retains the supply of the part material 66p or the support material 66s, along with carrier particles. The development stations 58 may function in a similar manner to single or dual component development systems and toner cartridges used in 2D electrophotography systems. For example, each development station 58 may include an enclosure for retaining the part material 66p or the support material 66s and carrier particles. When agitated, the carrier particles generate triboelectric charges to attract the powders of the part material 66p or the support material 66s, which charges the attracted powders to a desired sign and magnitude, as discussed below.

Each development station 58 may also include one or more devices for transferring the charged part or the support material 66p or 66s to the surface 46, such as conveyors, fur brushes, paddle wheels, rollers, and/or magnetic brushes. For instance, as the surface 46 (containing the latent charged image) rotates from the imager 56 to the development station 58 in the direction 52, the charged part material 66p or the support material 66s is attracted to the appropriately charged regions of the latent image on the surface 46, utilizing either charged area development or discharged area development (depending on the electrophotography mode being utilized). This creates successive layers 22p or 22s as the photoconductor drum 42 continues to rotate in the direction 52, where the successive layers 22p or 22s correspond to the successive sliced layers of the digital representation of the 3D part or support structure.

The successive layers 22p or 22s are then rotated with the surface 46 in the direction 52 to a transfer region in which layers 22p or 22s are successively transferred from the photoconductor drum 42 to the belt 24 or other transfer medium, as discussed below. While illustrated as a direct engagement between the photoconductor drum 42 and the belt 24, in some preferred embodiments, the EP engines 12p and 12s may also include intermediary transfer drums and/or belts, as discussed further below.

After a given layer 22p or 22s is transferred from the photoconductor drum 42 to the belt 24 (or an intermediary transfer drum or belt), the drive motor 50 and the shaft 48 continue to rotate the photoconductor drum 42 in the direction 52 such that the region of the surface 46 that previously held the layer 22p or 22s passes the cleaning station 60. The cleaning station 60 is a station configured to remove any residual, non-transferred portions of part or support material 66p or 66s. Suitable devices for the cleaning station 60 include blade cleaners, brush cleaners, electrostatic cleaners, vacuum-based cleaners, and combinations thereof.

After passing the cleaning station 60, the surface 46 continues to rotate in the direction 52 such that the cleaned regions of the surface 46 pass the discharge device 62 to remove any residual electrostatic charge on the surface 46, prior to starting the next cycle. Suitable devices for the discharge device 62 include optical systems, high-voltage alternating-current corotrons and/or scorotrons, one or more rotating dielectric rollers having conductive cores with applied high-voltage alternating-current, and combinations thereof.

The biasing mechanisms 16 are configured to induce electrical potentials through the belt 24 to electrostatically attract the layers 22p and 22s from the EP engines 12p and 12s to the belt 24. Because the layers 22p and 22s are each only a single layer increment in thickness at this point in the process, electrostatic attraction is suitable for transferring the layers 22p and 22s from the EP engines 12p and 12s to the belt 24.

The controller 36 preferably rotates the photoconductor drums 42 of the EP engines 12p and 12s at the same rotational rates that are synchronized with the line speed of the belt 24 and/or with any intermediary transfer drums or belts. This allows the system 10 to develop and transfer the layers 22p and 22s in coordination with each other from separate developer images. In particular, as shown, each part layer 22p may be transferred to the belt 24 with proper registration with each support layer 22s to produce a combined part and support material layer or combined image layer, which is generally designated as layer 22. As can be appreciated, some of the layers 22 transferred to the layer transfusion assembly 20 may only include support material 66s or may only include part material 66p, depending on the particular support structure and 3D part geometries and layer slicing.

In an alternative embodiment, the part layers 22p and the support layers 22s may optionally be developed and transferred along the belt 24 separately, such as with alternating layers 22p and 22s. These successive, alternating layers 22p and 22s may then be transferred to layer transfusion assembly 20, where they may be transfused separately to form the layer 22 and print or build the 3D part 26 and support structure.

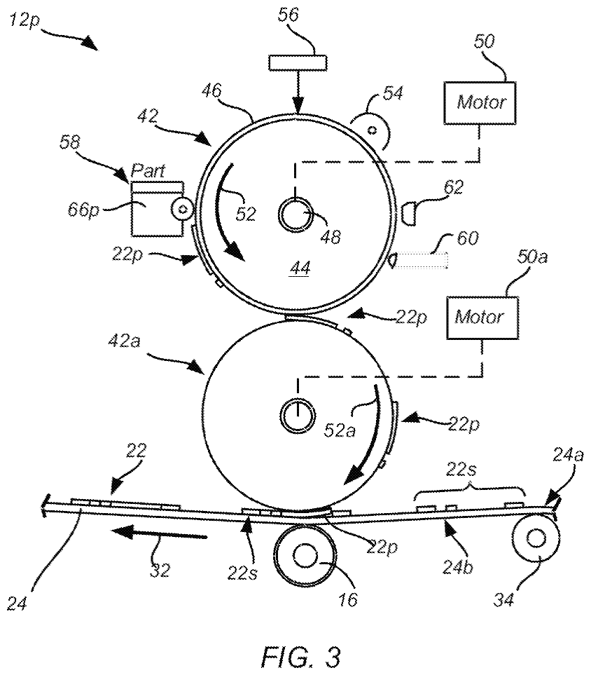

In a further alternative embodiment, one or both of the EP engines 12p and 12s may also include one or more intermediary transfer drums and/or belts between the photoconductor drum 42 and the belt or transfer medium (e.g. belt 24). For example, as shown in FIG. 3, the EP engine 12p may also include an intermediary drum 42a that rotates in the direction 52a that opposes the direction 52, in which drum 42 is rotated, under the rotational power of motor 50a. The intermediary drum 42a engages with the photoconductor drum 42 to receive the developed layers 22p from the photoconductor drum 42, and then carries the received developed layers 22p and transfers them to the belt 24.

The EP engine 12s may include the same arrangement of an intermediary drum 42a for carrying the developed layers 22s from the photoconductor drum 42 to the belt 24. The use of such intermediary transfer drums or belts for the EP engines 12p and 12s can be beneficial for thermally isolating the photoconductor drum 42 from the belt 24, if desired.

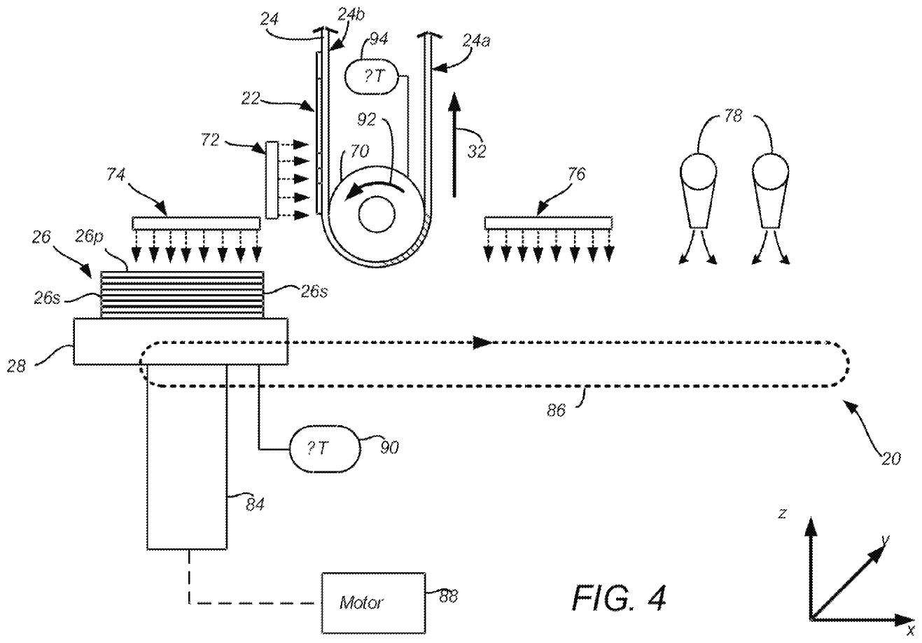

FIG. 4 illustrates an embodiment of the layer transfusion assembly 20. As shown, the exemplary transfusion assembly 20 includes the build platform 28, a nip roller 70, and pre-transfusion heaters 72 and 74. In some embodiments, the transfusion assembly includes, an optional post-transfusion heater 76, and/or a cooler (e.g., air jets 78 or other cooling units), as shown in FIGS. 1 and 4. The build platform 28 is a platform assembly or platen of system 10 that is configured to receive the heated combined layers 22 (or separate layers 22p and 22s) for printing the part 26, which includes a 3D part 26p formed of the part layers 22p, and support structure 26s formed of the support layers 22s, in a layer-by-layer manner. In some embodiments, the build platform 28 may include removable film substrates (not shown) for receiving the printed layers 22, where the removable film substrates may be restrained against build platform using any suitable technique (e.g., vacuum drawing).

The build platform 28 is supported by a gantry 84 or other suitable mechanism, which can be configured to move the build platform 28 along the z-axis and the x-axis (and, optionally, also the y-axis), as illustrated schematically in FIG. 1 (the y-axis being into and out of the page in FIG. 1, with the z-, x- and y-axes being mutually orthogonal, following the right-hand rule). The gantry 84 may produce cyclical movement patterns relative to the nip roller 70 and other components, as illustrated by broken line 86 in FIG. 4. The particular movement pattern of the gantry 84 can follow essentially any desired path suitable for a given application. The gantry 84 may be operated by a motor 88 based on commands from the controller 36, where the motor 88 may be an electrical motor, a hydraulic system, a pneumatic system, or the like. In one embodiment, the gantry 84 can included an integrated mechanism that precisely controls movement of the build platform 28 in the z- and x-axis directions (and optionally the y-axis direction). In alternate embodiments, the gantry 84 can include multiple, operatively-coupled mechanisms that each control movement of the build platform 28 in one or more directions, for instance, with a first mechanism that produces movement along both the z-axis and the x-axis and a second mechanism that produces movement along only the y-axis. The use of multiple mechanisms can allow the gantry 84 to have different movement resolution along different axes. Moreover, the use of multiple mechanisms can allow an additional mechanism to be added to an existing mechanism operable along fewer than three axes.

In the illustrated embodiment, the build platform 28 can be heatable with heating element 90 (e.g., an electric heater). The heating element 90 is configured to heat and maintain the build platform 28 at an elevated temperature that is greater than room temperature (25° C.), such as at a desired average part temperature of 3D part 26p and/or support structure 26s, as discussed in Comb et al., U.S. Patent Application Publication Nos. 2013/0186549 and 2013/0186558. This allows the build platform 28 to assist in maintaining 3D part 26p and/or support structure 26s at this average part temperature.

The nip roller 70 is an example heatable element or heatable layer transfusion element, which is configured to rotate around a fixed axis with the movement of the belt 24. In particular, the nip roller 70 may roll against the rear surface 22s in the direction of arrow 92 while the belt 24 rotates in the feed direction 32. In the shown embodiment, the nip roller 70 is heatable with a heating element 94 (e.g., an electric heater). The heating element 94 is configured to heat and maintain nip roller 70 at an elevated temperature that is greater than room temperature (25° C.), such as at a desired transfer temperature for the layers 22.

The pre-transfusion heater 72 includes one or more heating devices (e.g., an infrared heater and/or a heated air jet) that are configured to heat the layers 22 on the belt 24 to a selected temperature of the layer 22, such as up to a fusion temperature of the part material 66p and the support material 66s, prior to reaching nip roller 70. Each layer 22 desirably passes by (or through) the heater 72 for a sufficient residence time to heat the layer 22 to the intended transfer temperature. The pre-transfusion heater 74 may function in the same manner as the heater 72, and heats the top surfaces of the 3D part 26p and support structure 26s on the build platform 28 to an elevated temperature, and in one embodiment to supply heat to the layer upon contact.

The part and support materials 66p and 66s of the layers 22p and 22s may be heated together with the heater 72 to substantially the same temperature, and the part and support materials 66p and 66s at the top surfaces of the 3D part 26p and support structure 26s may be heated together with heater 74 to substantially the same temperature. This allows the part layers 22p and the support layers 22s to be transfused together to the top surfaces of the 3D part 26p and the support structure 26s in a single transfusion step as the combined layer 22. An optional post-transfusion heater 76 may be provided downstream from nip roller 70 and upstream from air jets 78, and configured to heat the transfused layers 22 to an elevated temperature in a single post-fuse step.

As mentioned above, in some embodiments, prior to building the part 26 on the build platform 28, the build platform 28 and the nip roller 70 may be heated to their selected temperatures. For example, the build platform 28 may be heated to the average part temperature (e.g., bulk temperature) of 3D part 26p and support structure 26s. In comparison, the nip roller 70 may be heated to a desired transfer temperature or nip entrance temperature for the layers 22.

As further shown in FIG. 4, during operation, the gantry 84 may move the build platform 28 (with 3D part 26p and support structure 26s) in a broken line 86. In particular, the gantry 84 may move the build platform 28 along the x-axis below, along, or through the heater 74. The heater 74 heats the top surfaces of 3D part 26p and support structure 26s to an elevated temperature, such as the transfer temperatures of the part and support materials. As discussed in Comb et al., U.S. Patent Application Publication Nos. 2013/0186549 and 2013/0186558, the heaters 72 and 74 may heat the layers 22 and the top surfaces of 3D part 26p and support structure 26s to about the same temperatures to provide a consistent transfusion interface temperature. Alternatively, the heaters 72 and 74 may heat layers 22 and the top surfaces of 3D part 26p and support structure 26s to different temperatures to attain a desired transfusion interface temperature.

The continued rotation of the belt 24 and the movement of the build platform 28 align or register the heated layer 22 (e.g., combined image layer) with the heated top surfaces of 3D part 26p and support structure 26s with proper registration along the x-axis. The gantry 84 may continue to move the build platform 28 along the x-axis, at a rate that is synchronized with the rotational rate of the belt 24 in the feed direction 32 (i.e., the same directions and speed). This causes the rear surface 24b of the belt 24 to rotate around the nip roller 70 to nip the belt 24 and the heated layer 22 against the top surfaces of 3D part 26p and support structure 26s. This presses the heated layer 22 between the heated top surfaces of 3D part 26p and support structure 26s at the location of the nip roller 70, which at least partially transfuses the heated layer 22 to the top layers of 3D part 26p and support structure 26s.

As the transfused layer 22 passes the nip of the nip roller 70, the belt 24 wraps around the nip roller 70 to separate and disengage from the build platform 28. This assists in releasing the transfused layer 22 from the belt 24, allowing the transfused layer 22 to remain adhered to 3D part 26p and support structure 26s. Maintaining the transfusion interface temperature at a transfer temperature that is higher than its glass transition temperature, but lower than its fusion temperature, allows the heated layer 22 to be hot enough to adhere to the 3D part 26p and support structure 26s, while also being cool enough to readily release from the belt 24. Additionally, as discussed above, the close melt rheologies of the part and support materials allow them to be transfused in the same step.

After release, the gantry 84 continues to move the build platform 28 along the x-axis to the post-transfusion heater 76. At optional post-transfusion heater 76, the top-most layers of 3D part 26p and the support structure 26s (including the transfused layer 22) may then be heated to at least the fusion temperature of the thermoplastic-based powder in a post-fuse or heat-setting step. This optionally heats the material of the transfused layer 22 to a highly fusible state such that polymer molecules of the transfused layer 22 quickly interdiffuse to achieve a high level of interfacial entanglement with 3D part 26p and support structure 26s.

Additionally, as the gantry 84 continues to move the build platform 28 along the x-axis past the post-transfusion heater 76 to the air jets 78, the air jets 78 blow cooling air towards the top layers of 3D part 26p and support structure 26s. This actively cools the transfused layer 22 down to the average part temperature, as discussed in Comb et al., U.S. Patent Application Publication Nos. 2013/0186549 and 2013/0186558.

To assist in keeping the 3D part 26p and support structure 26s at the average part temperature, in some preferred embodiments, the heater 74 and/or the heater 76 may operate to heat only the top-most layers of 3D part 26p and support structure 26s. For example, in embodiments in which heaters 72, 74, and 76 are configured to emit infrared radiation, the 3D part 26p and support structure 26s may include heat absorbers and/or other colorants configured to restrict penetration of the infrared wavelengths to within the top-most layers. Alternatively, the heaters 72, 74, and 76 may be configured to blow heated air across the top surfaces of 3D part 26p and support structure 26s. In either case, limiting the thermal penetration into 3D part 26p and support structure 26s allows the top-most layers to be sufficiently transfused, while also reducing the amount of cooling required to keep 3D part 26p and support structure 26s at the average part temperature.

The gantry 84 may then actuate the build platform 28 downward, and move the build platform 28 back along the x-axis to a starting position along the x-axis, following the broken line 86. The build platform 28 desirably reaches the starting position for proper registration with the next layer 22. In some embodiments, the gantry 84 may also actuate the build platform 28 and 3D part 26p/support structure 26s upward for proper registration with the next layer 22. The same process may then be repeated for each remaining layer 22 of 3D part 26p and support structure 26s.

After the transfusion operation is completed, the resulting 3D part 26p and support structure 26s may be removed from system 10 and undergo one or more post-printing operations. For example, support structure 26s may be sacrificially removed from 3D part 26p using an aqueous-based solution, such as an aqueous alkali solution. Under this technique, support structure 26s may at least partially dissolve in the solution, separating it from 3D part 26p in a hands-free manner.

In comparison, part materials are chemically resistant to aqueous alkali solutions. This allows the use of an aqueous alkali solution to be employed for removing the sacrificial support structure 26s without degrading the shape or quality of 3D part 26p. Examples of suitable systems and techniques for removing support structure 26s in this manner include those disclosed in Swanson et al., U.S. Pat. No. 8,459,280; Hopkins et al., U.S. Pat. No. 8,246,888; and Dunn et al., U.S. Patent Application Publication No. 2011/0186081; each of which are incorporated by reference to the extent that they do not conflict with the present disclosure.

Furthermore, after support structure 26s is removed, 3D part 26p may undergo one or more additional post-printing processes, such as surface treatment processes. Examples of suitable surface treatment processes include those disclosed in Priedeman et al., U.S. Pat. No. 8,123,999; and in Zinniel, U.S. Pat. No. 8,765,045.

As mentioned above, previously disclosed selective deposition processes require that the support material 66s used to form the support layers 22s and the support structure 26s, and the part material 66p used to form the part layers 22p and the 3D part 26p, needed to have substantially the same or similar rheologies (e.g., viscosity and storage modulus) within operating temperature ranges. This placed severe restrictions on the materials 66 that could be used in previously disclosed selective deposition processes.

Some embodiments of the present disclosure make use of substantially dissimilar materials 66 for forming the part structure 26p and the support structure 26s relative to the materials used in previously disclosed selective deposition processes. This leads to several advantages over the previously disclosed selective deposition processes including the expansion of the materials 66 that may be used to form the part structure 26p and the support structure 26s and other advantages discussed below in greater detail.

Embodiments of the present disclosure may be partially defined with reference to a nip entrance temperature and a bulk temperature. The nip entrance temperature generally relates to the temperature of the top 10 mils of the layer 22 as the layer 22 is being joined to the part surface by the nip roller 70. In some embodiments, the nip entrance temperature ranges from 180-380° C. depending on the materials 66p and 66s used to form the layer 22. For example, when the part material 66p is ABS, the nip temperature may range from 210-280° C.

The bulk temperature refers to the average temperature of the part at a depth of about 50-100 mils from the top surface of the part 26. In some embodiments, the bulk temperature ranges from about 60-180° C. depending on the materials 66p and 66s being used. When the part material 66p is ABS, the bulk temperature is generally maintained between 110-120° C.

Various techniques for measuring the nip entrance temperature may be used. In one example, a support or a layer 22 containing a temperature sensor, is fed to the nip roller 70 on the belt 24 to detect the nip entrance temperature. The temperature sensor may take on any suitable form, such as a thermocouple. Another suitable temperature sensor may be formed using a printed circuit board having exposed copper traces on a top surface for detecting the nip entrance temperature based on the temperature-dependent resistance of the copper traces. A pyrometer may also be used to detect the nip entrance temperature based on the infrared radiation at the nip entrance.

Various techniques may be used for measuring the bulk temperature of the part 26. One exemplary technique for directly measuring the bulk temperature of the part 26 involves building the part 26 on a support that includes a temperature sensor, such as a thermocouple, the printed circuit board mentioned above, or another suitable temperature sensor. After a thickness of the layers 22 built on the support reaches about 50-100 mils (e.g., about 100 layers 22), the bulk temperature of the part 26 can be detected by the temperature sensor of the support. The bulk temperature may also be measured indirectly by measuring the top surface temperature of the part 26 a few seconds (e.g., 1-4 seconds) after a layer 22 has been transfused to the part 26 and briefly cooled, and before the transfusion of the next layer 22 to the surface of the part 26. This temperature may be used to approximate the bulk temperature of the part 26. Thus, the bulk temperature may be estimated by measuring the surface temperature of the part 26 using a pyrometer or other suitable temperature sensor.

Embodiments of the present disclosure may also be partially defined with reference to the viscosity and/or the storage modulus of the materials 66, such as the part materials 66p and the support materials 66s. The viscosity of a material generally indicates a resistance of the material to flow. The lower the viscosity the more flowable the material. During the transfusion process it is generally desirable for the materials 66 have a viscosity at the nip entrance temperature that is sufficiently flowable to entangle the polymer chains (reptate) of the materials.

The storage modulus of a material generally indicates the resilience of the materials 66p and 66s to hold their printed shape and position in response to an applied pressure, such as that applied by the nip roller 70 during the transfusion process. Thus, the lower the storage modulus, the more malleable the material is. It is understood that the measurement of the storage modulus may be determined or estimated through a measurement of the shear modulus of the material 66. It is generally desirable for the storage moduli of the materials forming the part 26 to be high enough at the bulk temperature to maintain their printed shape and position in response to the pressure applied by the nip roller 70 during the transfusion process.

The values of the storage modulus (or shear modulus) and viscosity of the materials 66 may be measured at a given temperature using an oscillating plate rheometer. The oscillating plate rheometer is preferably configured to simulate conditions during the transfusion process, in which the layer 22 is pressed against the top surface of the part 26 for a duration of approximately 30-50 milliseconds. In some embodiments, the viscosity and shear modulus of a material at a given temperature are measured by oscillating the plate rheometer at a frequency of 20 Hz-2 kHz, such as 30-100 Hz, for example. The storage modulus may be determined based on the measured shear modulus using conventional conversion techniques.

Previously disclosed selective deposition processes required the support material 66s used to form the support layers 22s and the support structure 26s, and the part material 66p used to form the part layers 22p and the 3D part 26p, to have substantially similar viscosities at the nip entrance temperature, and substantially similar storage moduli at the bulk temperature. This was believed to be necessary to allow the part layers 22p and the support layers 22s to be transfused to the top surface of the 3D part 26p and the support structure 26s in a single transfusion step as the combined layer 22. Additionally, the close melt rheologies of the part and support materials 66p and 66s were believed to be necessary to allow the optional post-transfusion heater 76, which is located downstream from the nip roller 70 and upstream from the air jets 78, to post-heat the top surfaces of 3D part 26p and support structure 26s together in a single post-fuse step.

Some embodiments of the present disclosure make use of materials 66 to form the layers 22 of the 3D part 26p and support structure 26s having substantially dissimilar storage moduli and/or viscosities over operating temperature ranges relative to the materials used in previously disclosed selective deposition processes. In one embodiment, the materials 66 include a relatively flowable material, generally referred to as flowable material 66f, and a relatively resilient (e.g., less flowable) material, generally referred to as resilient material 66r, at operational temperatures of the selective deposition process. In some embodiments, the flowable material 66f has a low storage modulus relative to that of the resilient material 66r over the bulk temperature range, and/or the flowable material 66f has a lower viscosity relative to that of the resilient material 66r over the nip entrance temperature range. The use of these dissimilar materials as the part materials 66p and/or the support materials 66s, provides advantages over the previously disclosed selective deposition techniques using materials having substantially similar rheologies.

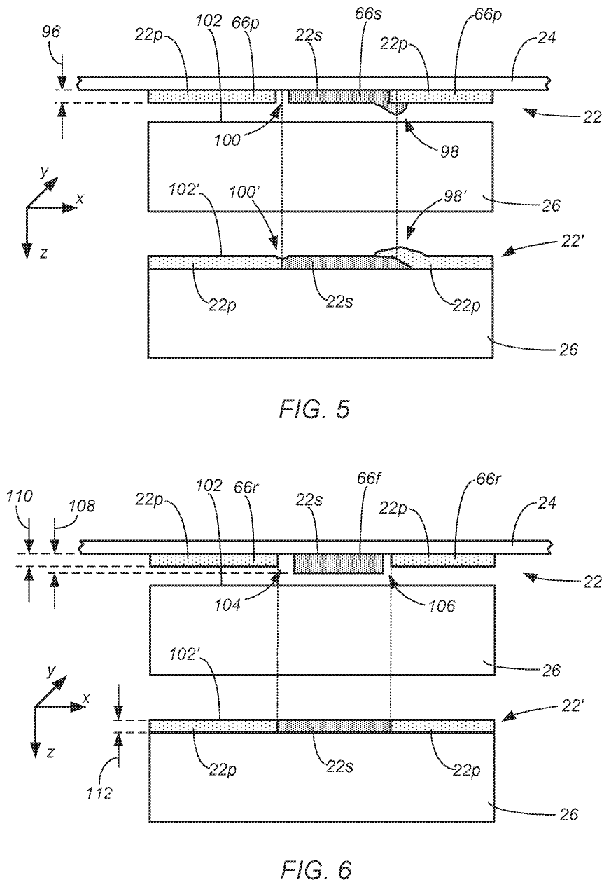

FIG. 5 is a simplified diagram illustrating a layer 22 on the transfer medium (e.g., belt 24) before transfer to the part 26 and after the layer 22 is transfused to the part 26 using the nip roller (not shown), in accordance with the previously disclosed selective deposition process utilizing materials 66p and 66s having the same or substantially similar rheologies. In the previously disclosed process, the portions 22p and 22s are printed to the transfer medium (e.g. belt 24) at a tight tolerance in the x-direction and the y-direction. Additionally, the portions 22p and 22s printed to the belt 24 have the same thickness 96 (measured in the z-direction). During the transfusion process, the portions 22p and 22s are expected to move toward a midway point within gaps between the portions 22p and 22s in response to the heat and pressure applied by the nip roller 70 (FIG. 4). The tight tolerance between the portions 22p and 22s on the transfer medium (e.g. belt 24) allows the thickness of the layer 22 to remain substantially uniform following its transfusion to the part 26, provided that the layers portions 22p and 22s are accurately printed to the belt 24 and do not overlap.

However, when there is misregistration between the portions 22p and 22s printed to the transfer medium (e.g. belt 24), such as in the x-direction as shown in FIG. 5, the portions 22p and 22s may overlap resulting in a bump 98 in the layer 22 and a gap 100 between the portions 22p and 22s. Following the transfusion process, the overlapping portions 22p and 22s of the transfused layer 22′ mix together and form a bump 98′ on the top surface 102 of the part 26, and the gap 100 in the layer 22 results in a depression 100′ in the top surface 102 of the part 26. This causes in an uneven build surface 102′ on the part 26, which may propagate through additional layers 22 that are transfused to the uneven surface 102, resulting in a defective part 26. Additionally, the areas where the portions 22p and 22s mix together at the bump 98′ can facilitate crack propagation initiation sites within the part 26.

Some embodiments of the present disclosure address these issues by expanding the tolerances between the portions of the layer 22 formed by the dissimilar flowable and resilient materials relative to the previously disclosed selective deposition process. In some embodiments, the portions 22p and 22s are printed or registered with respect to each other such that they are separated by gaps in the x-direction and/or the y-direction on the transfer medium. These gaps create larger spacing between the portions 22p and 22s relative to the previously disclosed selective deposition process, and decreases the likelihood of an overlap between the portions 22p and 22s formed of the dissimilar flowable and resilient materials. This is generally shown in the simplified diagram of FIG. 6, which illustrates the registration of portions 22p and 22s to form the combined layer 22 on the transfer medium (e.g., belt 24) before transfer to the part 26, and after the layer 22 is transfused to the part 26 using the nip roller (not shown). The large gaps 104 and 106 between the portions 22p and 22s on the belt 24 in the x-direction prevent the portions from overlapping. The spacing between the layers 22p and 22s provided by each of the gaps 104 and 106 is greater than that allowed in the previously disclosed selective deposition process.

In the exemplary selective deposition process shown in FIG. 6, the support portions 22s are formed of the flowable material 66f (support materials 66s in a relatively flowable form), and the part portions 22p are formed of the relatively resilient material 66r (part material 66p in a relatively resilient form). However, it is understood that the relatively flowable material 66f could be used to form part portions 22p and the relatively resilient material 66r could be used to form the support portions 22s.

In some embodiments, the flowable layer portions 22s of the layer 22 are printed with a greater thickness 108 (measured in the z-direction) than the thickness 110 of the relatively resilient layer portions 22p of the layer 22, as shown in FIG. 6. In some embodiments, the increase in the thickness of the portion 22s relative to that of the portion 22p is selected to provide sufficient volume of the material 66f to fill in the gaps 104 and 106 extending in the x-direction, as well as gaps between the portions 22p and 22s extending in the y-direction. In some embodiments, the layer portions formed of the flowable material 66f, such as the layer portion 22s in the example of FIG. 6, has a thickness 108 that greater than the thickness 110 of the resilient layer portions 22p, by greater than about 5%, 10%, 15%, 20%, 25%, 30%, 40% and/or 50%, for example.

During the transfusion process, the flowable material 66f of the portion 22s flows to fill in the gaps 104 and 106 while the resilient material 66r of the portions 22p generally remains in its printed position resulting in a transfused layer 22′ having a substantially uniform thickness 112. In some embodiments, the flowable material 66f fills more than 50% of the spacing between the layer portions 22p and 22s formed by the gaps (e.g., gaps 104 and 106) during the transfusion process, such as greater than 60%, greater than 70%, greater than 80%, and greater than 90%, for example. The resulting uniform thickness 112 of the transfused layer 22′ on the part 26 facilitates more accurate printing of the part 26 due to the flat build surface 102′, while reducing the occurrence of crack propagation initiation sites and other issues associated with the previously disclosed selective deposition process discussed above.

In some embodiments, the flowable material 66f is selected such that it has a substantially lower viscosity than the resilient material 66r at the nip entrance temperature, as compared to the materials used in previously disclosed selective deposition processes. In one embodiment, the resilient material 66r has a viscosity that is more than three times the viscosity of the flowable material 66f at the nip entrance temperature. Thus, when the viscosity of the flowable material 66f is Vf, the viscosity Vr of the relatively resilient material 66s is three times the viscosity Vf or more at the nip entrance temperature or the nip entrance temperature range of the selective deposition process. That is Vr≥3*Vf at the nip entrance temperature.

In some embodiments, the resilient material 66r can be much more rigid at the bulk temperature of the part than the flowable material 66f, as long as the lower temperature polymer is sufficiently rigid to resist buckling and inelastic distortion during the transfusion process to resist the pressure applied by the nip roller 70. In one embodiment, the materials 66r and 66f have storage moduli that are more than three times different over the bulk temperature range. Thus, the resilient material 66r is selected to have a storage modulus of Er and the relatively flowable material 66f is selected to have a storage modulus of Ef, where Er≥3*Ef at the bulk temperature or over the bulk temperature range of the selective deposition process.

Exemplary resilient materials 66r include thermoplastic elastomers, such as Arkema Pebax 9002 black, a semicrystalline combination of polyimide and polyether, or other suitable thermoplastic elastomers. One suitable flowable material 66f, which could be paired with the Arkema Pebax 9002 black is SS94 thermoplastic sold by Stratasys, Inc. of Eden Prairie, Minn. The SS94 thermoplastic has been used as a support material for acrylonitrile butadiene styrene (ABS), such as ABS MG94 sold by Stratasys, Inc., which has a substantially similar viscosity to the SS94 thermoplastic over the nip entrance temperature range, as well as a substantially similar storage modulus to the SS94 thermoplastic over the bulk temperature range. Other relatively resilient materials 66r that may be used include nylon, such as PA11 nylon, thermoplastic polyurethane, ABS and polyethersulfone (PES) combinations, ABS and polycarbonate (PC) combinations, and other suitable materials.

The resilient material 66r and/or the flowable material 66f that form the part material 66p and/or the support material 66s may be engineered for use with the particular architecture of the EP engine 12p or other electrostatographic engine. The materials 66r and/or 66f may compositionally include a thermoplastic polyurethane (TPU) polymer, a charge control agent, preferably, but optionally, a heat absorber (e.g., a carbon black or an infrared absorber), and optionally one or more additional materials, such as a flow control agent, as described in International Patent Application No. PCT/US2018/051941, filed on Sep. 20, 2018, which is incorporated herein by reference in its entirety.

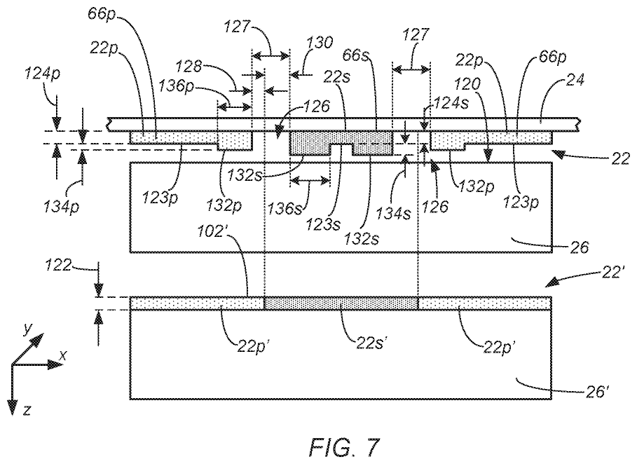

Additional embodiments of the present disclosure provide alternative techniques for avoiding an overlap of materials in a printed layer 22, such as the part material 66p forming the part portion 22p and the support material 66s forming the part portion 22s, as shown in FIG. 5, when the layer 22 is transfused to the build surface of the part 26. FIG. 7 is a simplified diagram illustrating an exemplary process of registering a printed layer 22 on a transfer medium (e.g., belt 24) with a build surface 120 of the part 26, and the resulting transfused layer 22′ on the part 26′, in accordance with embodiments of the present disclosure.

The part and support portions 22p and 22s of the printed layer 22 are formed by the materials 66p and 66s at a mass-per-unit-area (M/A) and density such that, when the materials 66p and 66s are fully sintered during the transfusion process, the incremental part thickness change is a thickness 122. For example, standard portion 123p of the part portion 22p and standard portion 123s of support portion 22s on the transfer medium (e.g. belt 24) are respectively configured to have a standard thickness 124p and 124s, such that the transfusion process results in the transfused portions 22p′ and 22s′ having the desired thickness 122.

Gaps 126 having a width 127 may be formed between the part and support portions 22p and 22s of the printed layer 22 in the x-direction (shown), and/or the y-direction to decrease the likelihood of an overlap between the portions 22p and 22s, as discussed above. During the transfusion process, the gaps 126 are filled by the part and support materials 66p and 66s of the part and support portions 22p and 22s, resulting in a transfused layer 22′ having the uniform thickness 122. This requires the part material 66p of the layers 22p to move into the gap 126 toward the support portion 22s a distance 128, and the support material 66s of the layer 22s to move into the gap 126 toward the part portions 22p a distance 130, during the transfusion process.

When the materials 66p and 66s are substantially similar to each other (e.g., same viscosities), the distances 128 and 130 may be about the same, and when the materials 66p and 66s are different (e.g., different viscosities), the distances 128 and 130 will be different. In general, relatively flowable materials will tend to move a greater distance into the gap 126 than relatively resilient materials, as discussed above. For example, when the part material 66p is relatively resilient and the support material 66s is relatively flowable, the distance 128 is less than the distance 130, as indicated in the exemplary process shown in FIG. 7.

In some embodiments, the volume of the gaps 126 to be filled by the part material 66p and/or the support material 66s during the transfusion process is accommodated by edge-enhancement bands 132 that adjoin the gaps 126, such as a band 132p of the part portion 22p and/or a band 132s of the support portion 22s, that correspond to perimeter areas of the portions 22p and 22s that are printed at a higher M/A than the standard portions 123p and 123s of the portions 22p and 22s that are displaced from the gaps 126. Thus, the bands 132 have a greater thickness than the standard portions 123. When the part material 66p and the support material 66s each have a sufficiently low viscosity such that the materials will flow into the gaps 126 during the transfusion process, the part portion 22p and the support portion 22s will each include the corresponding edge-enhancement band 132p and 132s. However, when one of the materials 66p or 66s is sufficiently resilient such that it will tend to remain in place during the transfusion process, such as described above with reference to FIG. 6, only the portion 22p or 22s formed of the relatively flowable material 66p or 66s must include an edge-enhancement band 132.

The volume of the bands 132p and 132s fills the gaps 126 during the transfusion process. The bands 132p and 132s are printed to the transfer medium 124 at band thicknesses of 134p and 134s. Additionally, the part portion band 132p has a width 136p and the support portion band 132s has a width 136s. The thickness 134 and width 136 parameters of the bands 132p and 132s are selected such that the extra mass in the bands 132p and 132s is sufficient to fill the portions of the gaps corresponding to the distances 128 and 130. Thus, the area of the part portion band 132p (thickness 134p multiplied by the width 136p) is equal to the corresponding area of the gap 126 (distance 128 multiplied by the thickness 124p) it is configured to fill during the transfusion process. Likewise, the area of the support portion band 132s (thickness 134s multiplied by the width 136s) is equal to the corresponding area of the gap 126 (distance 130 multiplied by the thickness 124s) it is configured to fill during the transfusion process.

Accordingly, embodiments of the method of printing the 3D part include, after setting the gap 126, determining (e.g., calculating or estimating) the distances 128 and 130 that the corresponding materials 66p and 66s will flow into the gap 126. In some embodiments, the distances 128 are determined based on the properties of the materials 66p and 66s (e.g., viscosity) at the nip entrance temperature and the length of the gap 126. Based on the distances 128 and 130, an area of the gap 126 to be filled by each of the materials 66p and 66s may be determined. Additionally, the method includes determining (e.g., calculating or estimating) the thicknesses 134p and 134s of the bands 132p and 132s (or the total thicknesses at the bands), and determining (e.g., calculating or estimating) the widths 136p and 136s of the bands 132p and 132s, based on the determined distances 128 and 130.

The edge-enhancement bands 132, which are specifically configured to fill the gaps 126, may be formed using any suitable technique. In some embodiments, the bands 132 are formed by configuring the EP engines 12p and 12s to print the bands 132p and 132s at a higher M/A than the adjoining standard portions 123p and 123s through grayscale or luminance control, or by halftoning. Alternatively, the edge-enhancement bands 132 may be printed by printing multiple layers of the materials 66p and 66s to initially form the portions 22p and 22s respectively having uniform thicknesses of 128 and 130, followed by the printing of the bands 132p and 132s in one or more additional layers. For example, the part portion 22p may be formed by printing n layers of the part material 66p at a constant M/A, followed by the printing of a single layer of the part material 66p that forms the band 132p. Here, the number of layers n would be approximately equal to the thickness 128 divided by the thickness 134p, and the width 136p can be varied based on the volume of the gap 126 to be filled (e.g., distance 128 multiplied by the thickness 134p).

Although the present disclosure has been described with reference to preferred embodiments, workers skilled in the art will recognize that changes may be made in form and detail without departing from the spirit and scope of the disclosure.

What is claimed is:

1. A method for printing a 3D part in accordance with a selective deposition additive manufacturing process, the method comprising:
developing a first image portion of a flowable material using a first electrophotographic engine;
developing a second image portion of a resilient material using a second electrophotographic engine;
registering the first image portion with respect to the second image portion to form a combined image layer comprising the first and second image portions on a transfer medium; and
transfusing the combined image layer from the transfer medium to a part build surface of a 3D part using a nip roller;
wherein:
the resilient material has a viscosity Vr at a nip entrance temperature corresponding to a surface temperature of the combined image layer at the nip roller;
the flowable material has a viscosity Vf at the nip entrance temperature; and
Vr≥3*Vf.

2. The method of claim 1, wherein the nip entrance temperature is 180-380° C.

3. The method of claim 1, wherein viscosities of the resilient material and the flowable material are measured using an oscillating plate rheometer.

4. The method of claim 3, wherein viscosities of the resilient material and the flowable material are measured using the oscillating plate rheometer oscillating at a frequency of 20 Hz-20 kHz.

5. The method of claim 4, wherein viscosities of the resilient material and the flowable material are measured using the oscillating plate rheometer oscillating at a frequency of 30-100 Hz.

6. The method of claim 1, wherein transfusing the combined image layer to a part build surface includes heating the part build surface.

7. The method of claim 1, wherein:
the resilient material has a storage modulus Er at a bulk temperature corresponding to an average temperature of the 3D part at depth of about 50-100 mils from the part build surface;
the flowable material has a storage modulus of Ef at the bulk temperature; and
Er≥3*Ef.

8. The method of claim 7, wherein the bulk temperature is 60-180° C.

9. The method of claim 8, wherein the storage moduli of the resilient material and the flowable material are determined using an oscillating plate rheometer.

10. A method for printing a 3D part in accordance with a selective deposition additive manufacturing process, the method comprising:
developing a first image portion of a flowable material using a first electrophotographic engine;
developing a second image portion of a resilient material using a second electrophotographic engine;
registering the first image portion with respect to the second image portion to form a combined image layer comprising the first and second image portions on a transfer medium; and
transfusing the combined image layer from the transfer medium to a part build surface of a 3D part;
wherein:
the resilient material has a storage modulus Er at a bulk temperature corresponding to an average temperature of the 3D part at depth of about 50-100 mils from the part build surface;
the flowable material has a storage modulus of Ef at the bulk temperature; and
Er≥3*Ef.

11. The method of claim 10, wherein the bulk temperature is 60-180° C.

12. The method of claim 11, wherein the storage moduli of the resilient material and the flowable material are determined using an oscillating plate rheometer.

13. The method of claim 12, wherein the storage moduli of the resilient material and the flowable material are determined using the oscillating plate rheometer oscillating at a frequency of 20 Hz-20 kHz.

14. The method of claim 13, wherein the storage moduli of the resilient material and the flowable material are determined using the oscillating plate rheometer oscillating at a frequency of 30-100 Hz.

15. The method of claim 10, wherein:
transfusing the combined image layer from the transfer medium to a part build surface of a 3D part comprises transfusing the combined image layer from the transfer medium to the part build surface of the 3D part using a nip roller;
the resilient material has a viscosity Vr at a nip entrance temperature corresponding to a surface temperature of the combined image layer at the nip roller;
the flowable material has a viscosity Vf at the nip entrance temperature; and
Vr≥3*Vf.

16. The method of claim 15, wherein the nip entrance temperature is 180-380° C.

17. The method of claim 15, wherein viscosities of the resilient material and the flowable material are measured using an oscillating plate rheometer.

18. A method for printing a 3D part in accordance with a selective deposition additive manufacturing process, the method comprising:
developing a first image portion of a flowable material using a first electrophotographic engine;
developing a second image portion of a resilient material using a second electrophotographic engine;
registering the first image portion with respect to the second image portion to form a combined image layer comprising the first and second image portions on a transfer medium; and
transfusing the combined image layer from the transfer medium to a part build surface of a 3D part using a nip roller;
wherein:
the resilient material has a viscosity Vr at a nip entrance temperature corresponding to a surface temperature of the combined image layer at the nip roller;
the flowable material has a viscosity Vf at the nip entrance temperature;
Vr≥3*Vf;
the resilient material has a storage modulus Er at a bulk temperature corresponding to the average temperature of the 3D part at depth of about 50-100 mils from the part build surface;
the flowable material has a storage modulus of Ef at the bulk temperature; and
Er≥3*Ef.

19. The method of claim 18, wherein:
the nip entrance temperature is 180-380° C.; and
the bulk temperature is 60-180° C.

20. The method of claim 18, wherein the viscosities and storage moduli of the resilient material and the flowable material are determined using an oscillating plate rheometer.
